(19) United States
(12) Patent Application Publication
(10) Pub. No.: US 2024/0208774 A1
(43) Pub. Date: Jun. 27, 2024

(54) APPARATUS AND METHOD FOR CONTROLLING OPERATIONS OF A SCREENLESS ELEVATOR

(71) Applicant: MARKETON INC, Seoul (KR)

(72) Inventor: Chang Joon Yang, Seoul (KR)

(73) Assignee: MARKETON INC, Seoul (KR)

(21) Appl. No.: 17/928,812

(22) PCT Filed: Aug. 31, 2022
(86) PCT No.: PCT/KR2022/013055

§ 371 Date: Nov. 30, 2022

(30) Foreign Application Priority Data
Aug. 31, 2021 (KR) 10-2021-0115526

(51) Int. Cl. B66B 1/52; G03H 1/00

(52) U.S. Cl. CPC B66B 1/52; G03H 1/0005; B66B 2201/46; G03H 2001/0061

(57) ABSTRACT

An apparatus and method for controlling operation of screenless elevator is provided. An apparatus for controlling operations of a screenless elevator includes: a display unit that displays a first image including a dial-shaped image; a hologram projection unit that displays a second image in the air, projecting the first image; a motion recognition unit that emits light to the second image and receives light reflected by a hand gesture of a user from the second image to recognize hand gesture of the user; and an operation control unit that controls operations of the elevator according to hand gesture of the user.

### TECHNICAL FIELD

The present disclosure relates to an apparatus and method for controlling operations of a screenless elevator.

### BACKGROUND ART

People in modern society touch and come into contact with elevator buttons to operate elevators in daily life. However, there may be a risk of infection, such as virus, due to the physical contact of the button for operating elevators, and buttons may be damaged.

Particularly, in order not to physically touch elevator buttons due to the recent rapid increase in the risk of infection due to COVID 19, in most cases, buttons are pressed by putting a plastic on the buttons or using an object without using user's finger.

Accordingly, there is a need for a method that can control the operation of elevators without physically contacting elevators used by the public.

### SUMMARY

### Technical Problem

To solve the above problems, the present disclosure provides an apparatus and method for controlling operations of a screenless elevator which may be capable of operating an elevator without a direct contact with buttons of the elevator.

The problems to be solved by the present disclosure are not limited to the problems mentioned above, and other problems not mentioned may be clearly understood by a person having an ordinary skill in the art from the description below.

### Solution to Problem

In a general aspect, an apparatus for controlling operations of a screenless elevator in accordance with examples of the disclosure includes: a display unit displaying a first image including a dial-shaped image; a hologram projection unit displaying a second image in air, projecting the first image; a motion recognition unit recognizing hand gesture of a user with respect to the second image by emitting light to the second image and receiving light reflected by the user's hand gesture from the second image; and an operation control unit controlling an elevator to be operated by the hand gesture of the user.

The display unit may display at least one of a floor number image displaying floor numbers of the elevator or an additional image displaying information relating to the elevator together with the dial-shaped image.

The hologram projection unit may project the first image onto a first region predetermined based on three-dimensional coordinate system to display the second image.

The motion recognition unit may detect, when at least three fingers of the user touch and turn the dial-shaped image within a second region predetermined based on the three-dimensional coordinate system, a spin angle and a spin speed spun by at least three fingers of the user.

The motion control unit may control the display unit such that the floor number image that displays floor number of the elevator is altered depending on the spin angle and the spin speed.

The motion recognition unit may detect, when five fingers of the user touch and spin the dial-shaped image, a spin angle and a spin speed spun by the five fingers of the user.

The operation control unit may control the display unit, when the spin angle is greater than or equal to a reference angle and the spin speed is greater than or equal to a reference speed, such that the floor number image displaying floor number of the elevator is altered in units of ten floors.

The operation control unit may control the display unit, when the spin speed is less than a reference speed, such that the floor number image displaying floor number of elevator is altered in units of one floor.

The motion recognition unit may recognize that a finger of the user touches the center area of the dial-shaped image when a first touch motion is made at a specific point within a center area of the dial-shaped image in a first direction where one finger of the user approaches the second image and a second touch motion is made at the specific point by moving one finger of the user in a second direction opposite to the first direction.

The operation control unit may, when the center area of the dial-shaped image is recognized as being touched, control the display unit such that the center area of the dial-shaped image is displayed with emphasis.

The motion recognition unit may include: a light emitting module radiating an incident light to the second image; a light receiving module receiving a reflected light reflected from the second image by a hand gesture of the user; and an arithmetic module detecting the hand gesture of the user based on the incident light and the reflected light and calculating motion information by the hand gesture.

In another aspect, a method for controlling operations of a screenless elevator in accordance with one or more examples of the present disclosure includes: displaying a first image including a dial-shaped image; displaying a second image projecting the first image onto a first region predetermined based on three-dimensional coordinate system; recognizing hand gesture of the user regarding the second image within a second region predetermined based on the three-dimensional coordinate system; and controlling operation such that an elevator operates in accordance with the hand gesture of the user.

The recognizing hand gesture may include detecting, when at least three fingers of the user touch and spin the dial-shaped image within the second region, a spin angle and a spin speed that three fingers of the user spin.

The method may further include altering the first image such that a floor number image displaying floor number of the elevator is altered depending on the spin angle and spin speed.

The recognizing hand gesture may include: recognizing, when five fingers of the user touch and spin the dial-shaped image within the second region, a spin angle and spin speed spun by five fingers of the user.

The method may further include altering, when the spin angle is greater than or equal to a reference angle and the spin speed is greater than or equal to a reference speed, the first image such that a floor number image displaying floor number of the elevator is altered in units of ten floors.

The method may further include altering the first image, when the spin speed is less than reference speed, such that floor image displaying floor number of the elevator is altered in units of one floor.

Other details of the disclosure are included in detailed description and drawings.

### Effects of Invention

According to the present disclosure, it may be able to prevent infection through contact by applying it to elevators requiring a simple touch of buttons, and a dial-shaped hologram that is visually recognizable and is operated by a hand rotation gesture may allow users to simple use it.

### BRIEF DESCRIPTION OF DRAWINGS

FIG. 1 illustrates a view of the appearance of an apparatus for controlling operations of a screenless elevator in accordance with one or more examples of the present disclosure.

FIG. 2 illustrates a block diagram of an apparatus for controlling operations of a screenless elevator in accordance with one or more examples of the present disclosure.

FIG. 3 illustrates a view showing in detail a feature of displaying an image by an apparatus for controlling operations of a screenless elevator in accordance with one or more examples of the present disclosure.

FIG. 4 illustrates a view of a state where a user uses an apparatus for controlling operations of a screenless elevator in accordance with one or more examples of the present disclosure.

FIG. 5 illustrates a view of an example of a second image displayed in the air.

FIG. 6 illustrates a view of the structure of a hologram projection unit of a hologram touch display unit in accordance with one or more examples of the present disclosure.

FIG. 7 illustrates a view for explaining a movement path of light in the hologram projection unit of FIG. 6.

FIG. 8 illustrates a view of the detailed structure of a motion recognition unit of a hologram touch display unit in accordance with one or more examples of the present disclosure.

FIG. 9 illustrates a view of a sensor array in which a light emitting module and a light receiving module of the motion recognition unit of the FIG. 8 are configured as one body.

FIG. 10 illustrates a view of a method for controlling operations of a screenless elevator in accordance with one or more examples of the present disclosure.

### BEST MODE FOR IMPLEMENTATION OF THE INVENTION

There is provided an apparatus for controlling operations of a screenless elevator includes: a display unit that displays a first image including a dial-shaped image; a hologram projection unit that displays a second image in the air, projecting the first image; a motion recognition unit that emits light to the second image and receives light reflected by a hand gesture of a user from the second image to recognize the user's hand gesture regarding the second image; and an operation control unit that controls such that the elevator operates according to the user's hand gesture.

### METHOD FOR CARRYING OUT THE INVENTION

The advantages and features of the disclosure, and the manner of achieving them will be apparent from and elucidated with reference to the embodiments described hereinafter in conjunction with the attached drawings. Hereinafter, a detailed description of known functions and configurations incorporated herein will be omitted when it may make the subject matter of the disclosure unclear.

The following terms are defined in consideration of the functions of the disclosure, and these may be changed according to the intention of the user or operator. The disclosure may, however, be embodied in many different forms and should not be construed as being limited to the embodiments set forth herein. Rather, these embodiments are provided so that this disclosure will be thorough and complete, and will fully convey the scope of the invention to those skilled in the art. The invention is only defined by the scope of the claims. Therefore, the definition should be based on the contents throughout this specification.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

The features described herein may be embodied in different forms, and are not to be construed as being limited to the examples described herein. In this specification, the singular also includes the plural unless specifically stated otherwise in the phrase. The terms “comprises” and/or “made of” in this specification do not exclude the presence or addition of a referenced component, step, operation and/or element of one or more other components, steps, operations and/or elements.

Unless otherwise defined, all terms (including technical and scientific terms) used in this specification may be used with meanings that can be commonly understood by those of ordinary skill in the art to which the present invention belongs. In addition, terms defined in a commonly used dictionary are not to be interpreted ideally or excessively unless clearly specifically defined.

A detailed description for the disclosure will be given below with attached drawings.

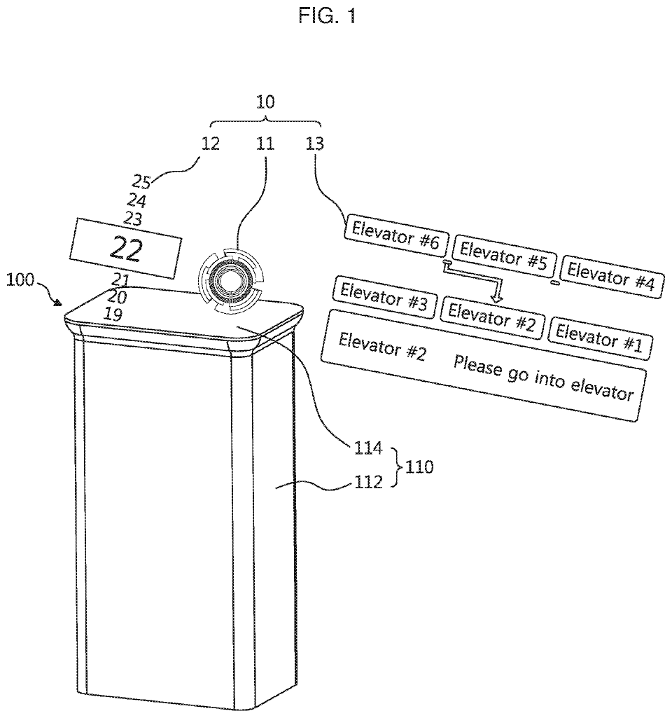

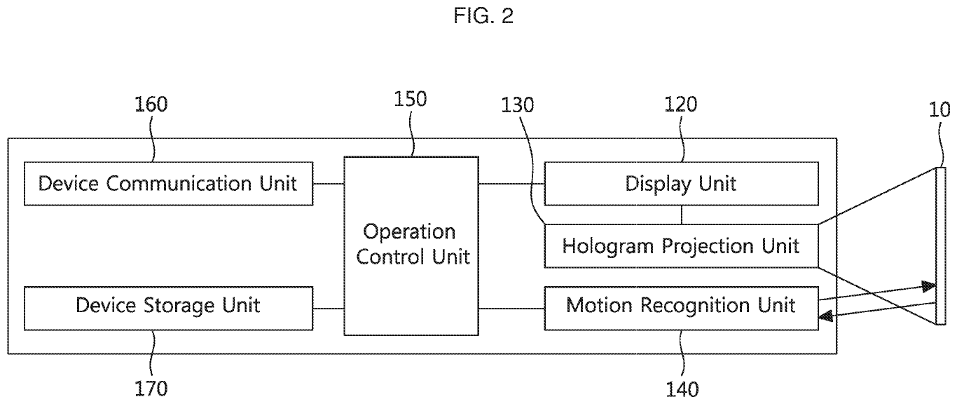

FIG. 1 illustrates a view of appearance of an apparatus for controlling operations of a screenless elevator in accordance with one or more examples of the present disclosure. In addition, FIG. 2 illustrates a block diagram of an apparatus for controlling operations of a screenless elevator in accordance with one or more examples of the present disclosure.

Referring to FIGS. 1 and 2, an apparatus for controlling operations of a screenless elevator in accordance with one or more examples includes a housing unit 110, a display unit 120, a hologram projection unit 130, a motion recognition unit 140, an operation control unit 150, a device communication unit 160, a device storage unit 170, etc.

The housing unit 110 may include: a housing module 112 for arranging the display unit 120, hologram projection unit 130, operation control unit 150, etc., its inside; and a penetration module 114 that closes an open side of the housing module 112 and in which an image of the hologram projection unit 130 displaying an image of the display unit 120 in the air is penetrated.

The housing module 112 maintains the inside in a dark room, and the penetration module 114 is located on the hologram projection unit 130, such that the image passing through the hologram projection unit 130 is penetrated and is projected in the air.

The display unit 120 displays a dial-shaped image and displays a first image including the dial-shaped image. The display unit 120 displays the first image, using a light source such as a display device, an OLED device.

At this time, the display unit 120 may display at least one of a floor number image that displays a floor number of an elevator or an additional image that displays information relating to the elevator, together with the dial-shaped image.

For example, to display the second image 10 in the air, the display unit 120 may display a dial-shaped image at the center, display a floor number image displaying a floor number of the elevator at a side of the dial-shaped image, and display an additional image displaying information relating to the elevator at another side of the dial-shaped image. Herein, the dial-shaped image may display a shape that rotates via a rotation motion after the user touches it, and the floor number image may display a shape that moves up and down via a drag motion after the user touches it.

The hologram projection unit 130 displays a second image 10 in the air, projecting the first image. Herein, the second image 10 is a hologram image that is projected in the air including the dial-shaped image. The hologram is a technique that records and reproduces three-dimensional information by using an interference phenomenon caused by two lights meeting each other. The second image 10 may look as if a dial-shaped image and so on is floating in the air and may provide an effect as if the user sees a three-dimensional stereoscopic image.

A second image including a dial-shaped image 11, a floor number image 12, and an additional image 13 is displayed in the air through the hologram projection image 130, including an image displayed by the display unit 120.

The motion recognition unit 140 emits light to the second image and receives light that is reflected by a user's hand gesture from the second image and thus recognizes the user's hand gesture of the second image.

For example, if the user touches the dial-shaped image with a plurality of fingers and spins it in a desired direction, information on the user's motion may be checked in a manner where a light at a particular position reflected by the user's hand gesture is detected.

The user's wrist spins with respect to a virtual plane where the dial-shaped image is generated and then the spin angle is recognized as motion information.

The operation control unit 150 controls, such that an elevator operates according to the user's hand gesture. The operation control unit 150 is connected to the elevator and operates according to control signals of the operation control unit 150.

In detail, the user spins the dial-shaped image floating in the air for a desired floor number, and a floor number corresponding thereto is displayed at one side. When the desired floor number is displayed, the user lightly touches the center of the dial with a finger and then a floor number is set, and a signal is transmitted to the set floor number of the elevator.

For example, turning the dial-shaped image to the left decreases a number to a lower number, and turning it to the right increases a number to a higher number. Adjust the number to be the number of a floor of the building that the user desires. A number is set if the center of the dial-shaped image is lightly touched within 3 seconds; otherwise, it is canceled after 3 seconds. If it is set to a desired number of a floor, a screen alters and the number of an elevator to get on may be informed.

In addition, the user may be able to select a desired floor number by dragging a floor number image. For example, dragging the floor number image up increases numbers, and dragging the floor number image down decreases numbers. Adjust the number to be the number of a floor of the building that the user desires. After that, when the center of the dial-shaped image is lightly touched, the elevator is controlled to move to a floor that the user desires.

Such operation control unit 150 takes a role of controlling the display unit 120, motion recognition unit 140, device communication unit 160, device storage unit 170, etc.

The device communication unit 160 takes a role of communicating with an external elevator. The device communication unit 160 is connected to the external elevator through a network (not shown) to transmit and receive data. Herein, the network includes a wired/wireless network.

The wired network may connect the hologram touch display unit 100 and external devices, such as ATM, elevator, entrance door lock, etc., using standards such as RS-485, RS232C.

The wireless network may use Wi-Fi, Bluetooth, Zigbee, Near Field Communication (NFC), Wibree, etc. For example, Bluetooth is one of the short-distance wireless communication standards. It wirelessly connects and controls many kinds of electronic and information communication devices within a radius of 10 to 100 m and uses a frequency of 2.45 Ghz; Wibree uses a frequency of 2.4 Ghz band and wirelessly connects and controls multiple devices at a communication speed of 1 Mbps for a distance of up to 10 m. Of course, it may be apparent to those having ordinary skill in the art that other wireless communication methods may be adopted without being limited to the short-range wireless communications.

The device communication unit 160 communicates with an external device and may communicate using RS-485 and the like. The operation control unit 150 generates a control signal according to keypad touch information and transmits it to an external device via the device communication unit 160.

The device storage unit 170 stores various data and information. For example, the device storage unit 170 stores an image that is displayed on the display unit 120, a program for generating a control signal of the operation control unit 150 base on motions recognized by the motion recognition unit 140, etc.

Additionally, although it is not shown in the drawings, the apparatus for controlling operations of a screenless elevator 100 may further include a proximity sensor (not shown) in order to recognize a user approaching the apparatus for controlling operations of a screenless elevator 100.

The proximity sensor for recognizing the approach of the user allows to prevent the second image from being projected by projecting the second image only when the user approaches.

Additionally, although it is not shown in the drawings, the apparatus for controlling operations of a screenless elevator 100 may further include a notification unit (not shown) for expressing a sound and so on to the outside.

The notification unit generates an effect sound as if a dial is turned when turning a dial-shaped image. In addition, the notification unit may allow to provide various information to the user with sound.

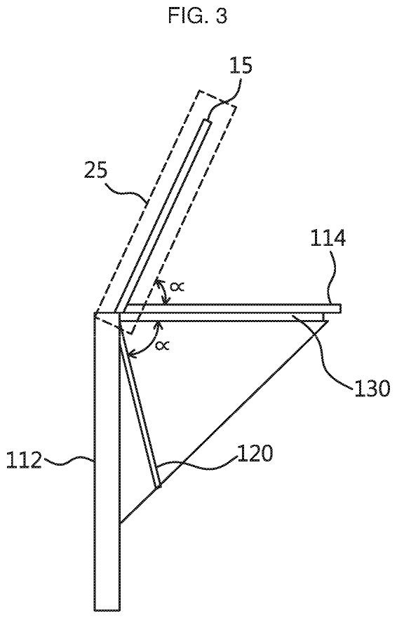

FIG. 3 illustrates a view showing in detail a feature of displaying an image by an apparatus for controlling operations of a screenless elevator in accordance with one or more examples of the present disclosure.

Referring to FIG. 3, a first image displayed at a display unit 120 located inside of a housing module 112 is projected by a hologram projection unit 130 to a predetermined first region 15 based on three-dimensional coordinate system to display a second image. The hologram projection unit 130 is located under a penetration module 114. Herein, the display unit 120 and the first region 15 may be located symmetrical to each other with respect to the hologram projection unit 130. Accordingly, the first image displayed at the display unit 120 and the second image projected to the first region 15 may be displayed at the same angle with respect to the hologram projection unit 130. When the first image displayed at the display unit 120 and the second image projected to the first region 15 are each displayed at the same angle with respect to the hologram projection unit 130, a motion recognition unit 140 may be located at a symmetrical point. For example, in FIG. 3, the motion recognition unit 140 may be located at a point where the housing module 112 and the hologram projection module 130 meet.

As illustrated in FIG. 3, the hologram projection unit 130 may be operated in a manner where: a first image is projected to a first region 15 predetermined based on three-dimensional coordinate system to display a second image and the user brings his/her finger and so on into contact with a desired location of the second image projected to the first region 15 and turn his/her hand.

The motion recognition unit 140 may check motion information by detecting the user's hand gesture within a second region 25 predetermined based on three-dimensional coordinate system in response to the dial-shaped image included in the second image.

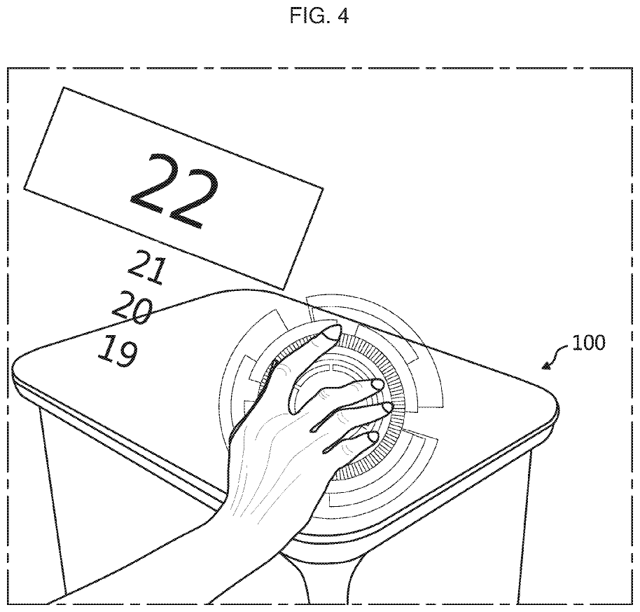

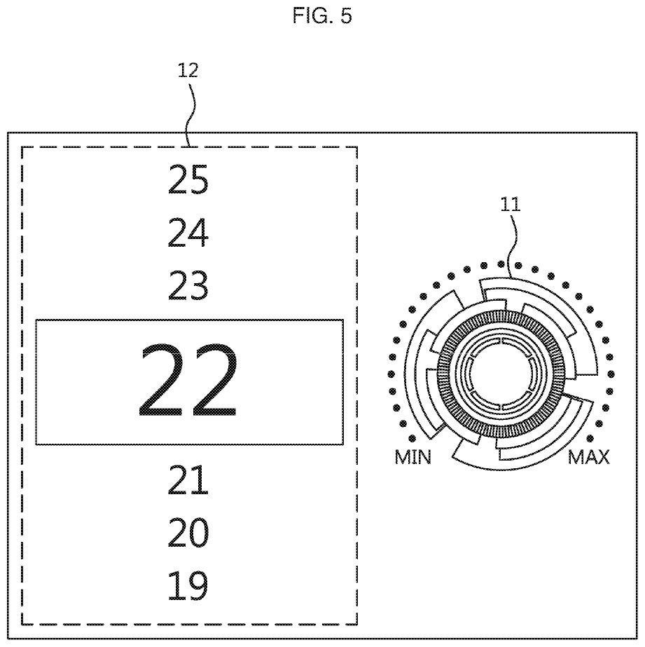

FIG. 4 illustrates a view of a state where a user uses an apparatus for controlling operations of a screenless elevator in accordance with one or more examples of the present disclosure. Further, FIG. 5 illustrates a view of an example of a second image displayed in the air.

Referring to FIGS. 4 and 5, in an apparatus for controlling operations of a screenless elevator 100, the user touches a dial-shaped image 11 included in the second image projected in the air with his/her finger to operate a floor number image 12 of the elevator.

In detail, the user locates his/her finger at the dial-shaped image 11 included in the second image and turns the image, then, the floor number image 12 of the elevator is controlled.

For example, when at least three fingers of the user touch and turn the dial-shaped image 11 within the second region predetermined based on three-dimensional coordinate system, the motion recognition unit 140 may detect a spin angle and spin speed spun by at least three fingers of the user. Accordingly, the operation control unit 150 controls the display unit 120 such that the floor number image 12 displaying an elevator's floor number is altered depending on the spin angle and spin speed.

For example, the user's five fingers touch and turn the dial-shaped image 11, the motion recognition unit 140 may detect a spin angle and spin speed spun by five fingers of the user. In this case, the operation control unit 150 controls the display unit 120 such that the floor number image 12 displaying the elevator's floor number is altered in units of ten (10) floors when a spin angle is greater than or equal to a reference angle and a spin speed is greater than or equal to a reference speed. Additionally, the operation control unit 150 controls the display unit 120 such that the floor number image 12 displaying the elevator's floor number is altered in unit of one (1) floor when the spin angle is less than the reference angle and the spin speed is less than the reference speed.

In particular, when a first touch motion at a specific point in the center area of the dial-shaped image 11 is performed in a first direction where one finger of the user approaches the second image 10 and a second touch motion is performed at the specific point by moving one finger of the user at a second direction opposite to the first direction, the motion recognition unit 140 may recognize that the user's finger touched the center area of the dial-shaped image 11.

At this time, the operation control unit 150 may control the display unit such that the center area of the dial-shaped image 11 is displayed with highlight when the center area of the dial-shaped image 11 is recognized as being touched. For example, the center area of the dial-shaped image 11 may be enlarged and displayed, or the center area of the dial-shaped image 11 may be emphasized with a different color. Alternatively, the center area of the dial-shaped image 11 may be displayed by blinking or a ripple effect of a wavy shape may be displayed at a portion touched.

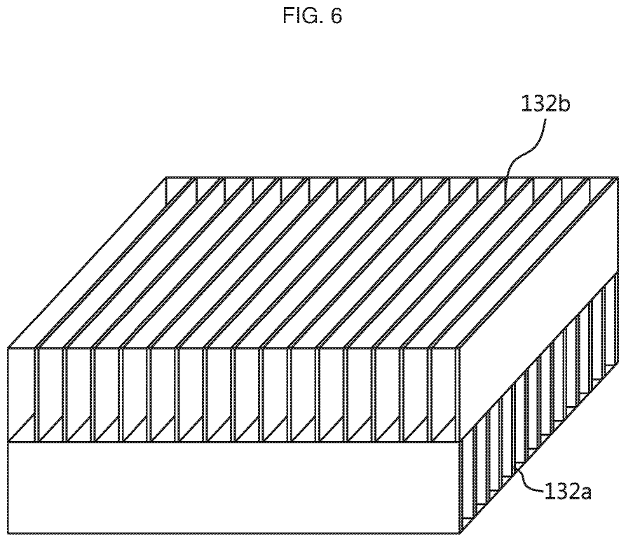

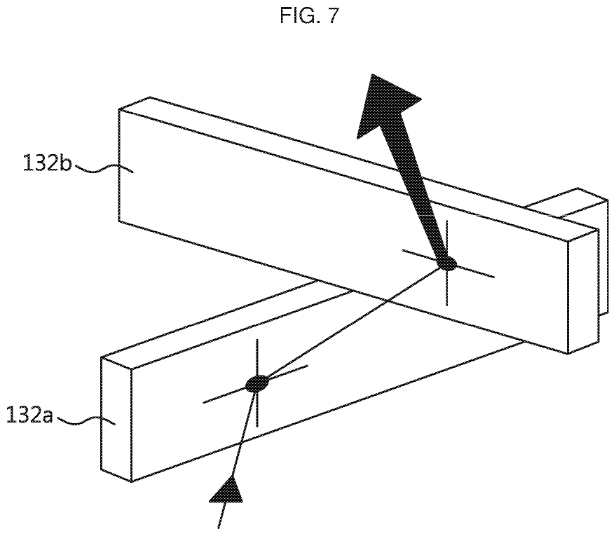

FIG. 6 illustrates a view of configuration of a hologram projection unit of a hologram touch display unit in accordance with one or more examples of the present disclosure. Additionally, FIG. 7 illustrates a view for explaining a movement path of light in the hologram projection unit of FIG. 6.

Referring to FIGS. 6 and 7, in the hologram projection unit 130, hologram plates 132a, 132b arranged at 90 degrees to each other may be regularly arranged.

As illustrated in FIG. 6, the hologram plate 132a arranged at a predetermined interval along a horizontal axis and the hologram plate 132b arranged at a predetermined interval along a vertical axis may be positioned vertically.

As illustrated in FIG. 7, a light incident from the display unit 120 is reflected from one hologram plate 132a and reflected from another hologram plate 132b positioned at an angle of 90 degrees to become a hologram and thus a second image is displayed in the air.

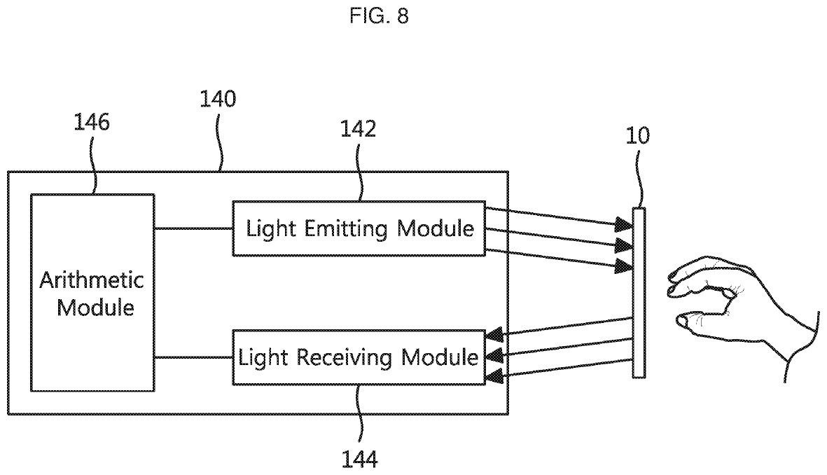

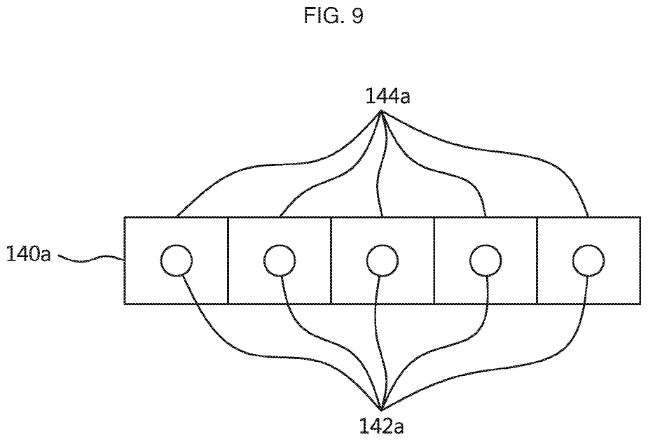

FIG. 8 illustrates a view of the detailed structure of a motion recognition unit of a hologram touch display unit in accordance with one or more examples of the present disclosure. Further, FIG. 9 illustrates a view of a sensor array in which a light emitting module and a light receiving module of the motion recognition unit of the FIG. 8 are configured as one body.

Referring to FIG. 8, the motion recognition unit 140 may include a light emitting module 142 that irradiates an incident light perpendicular to the second image 10, in particular, the dial-shaped image 11 of the second image 10, a light receiving module 144 that receives a reflected light reflected the second image 10 by the user's hand motion, and an arithmetic module 146 that detects the user's hand motion based on the incident light and the reflected light and calculates motion information by the hand motion.

The light emitting module 142 irradiates light to detect the user's hand motion, it may generate an independent optical signal so that the hand motion can be accurately recognized within a second region predetermined based on a three-dimensional coordinate system.

The light receiving module 144 receives the reflected light generated as the user's finger touches and turns the dial-shaped image 11 of the second image 10 and transmits it to the arithmetic module 146.

The arithmetic module 146 detects the difference using the incident light of the light emitting module 142 and the reflected light of the light receiving module 144 and detects a spin angle and speed spun by the user's hand.

The light emitting module 142 and the light receiving module 144 may be integrated in correspondence with each other in order to accurately detect a spin angle and a spin speed spun by the user's hand motion.

Referring to FIG. 9, the light emitting module 142 of the motion recognition unit 140 includes a plurality of light emitters 142a, and a light receiving module 144 includes a plurality of light receivers 144a. There may be included a sensor array 140a in which unit sensor module formed of one light emitter and one light receiver is arranged in a line.

That is, the light emitting module 142 includes a plurality of light emitters 142a, and a light emitted from the plurality of light emitters 142a is vertically irradiated to the second image 10.

In addition, the light receiving module 144 includes a plurality of light emitters 124a in one-to-one correspondence with the plurality of light emitters 142a, and accordingly, a change in the intensity of light vertically radiated from the light emitting module 142 to the second image 10 can be accurately recognized via the plurality of light receivers 144a.

A unit sensor module is formed of one light emitter 142a and one light receiver 144a, and the unit sensor modules are gathered to from a sensor array 140a. Herein, in the unit sensor module, the light emitter 142a is arranged at the front center of the light receiver 144a, and the light radiated from the light emitter 142a and reflected from the second image 10 is reflected to the light receiver 144a.

Since the unit sensor module is formed of one light emitter 142a and one light receiver 144a, it may be able to check accurately and quickly a spin angle and a spin speed by a user's hand motion.

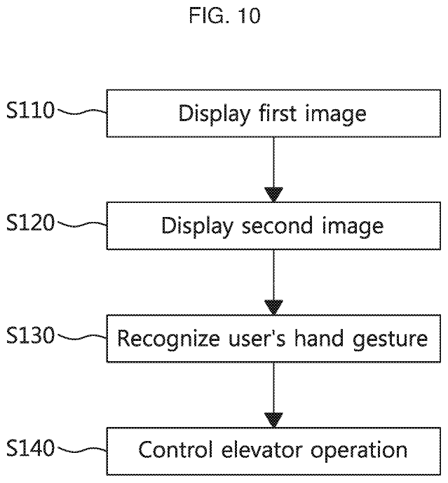

FIG. 10 illustrates a view of a method for controlling operations of a screenless elevator in accordance with one or more examples of the present disclosure.

Referring to FIG. 10, a method for controlling operations of a screenless elevator in accordance with one or more examples of the present disclosure is displaying a first image including a dial-shaped image (S110), displaying a second image, projecting the second image onto a first region predetermined based on three-dimensional coordinate system (S120), recognizing the user's hand motion regarding the second image within a second region predetermined based on the three-dimensional coordinate system (S130), and controlling the elevator to operate in accordance with the user's hand motion.

At this time, when recognizing a hand motion, if at least three fingers of the user touch and turn the dial-shaped image within the second region, a spin angle and spin speed spun by at least three fingers may be detected. Herein, the first image may be changed such that a floor number image displaying a floor number of the elevator is altered according to a spin angle and a spin speed.

In addition, when recognizing a hand motion, if five fingers of the user touch and turn the dial-shaped image within the second region, a spin angle and spin speed spun by the user's five fingers may be detected. Herein, when the spin angle is greater than or equal to a reference angle and the spin speed is greater than or equal to a reference speed, a first image may be changed such that a floor number image displaying the elevator's floor number is altered in units of ten (10) floors. When the spin speed is less than a reference speed, the first image may be changed such that a floor number image displaying the elevator's floor number is altered in units of one (1) floor.

A specific usage example of the method for controlling operations of a screenless elevator will be described.

A user poses with a finger holding a dial-shaped image floating in the air. Therein, the user may grasp the dial-shaped image using at least three fingers.

The user rotates fingers 45 degrees to the right. Then, on the left, a floor number is altered to the number of the elevator going up. Alternatively, the user rotates fingers 45 degrees to the left. Then, on the left, the floor number is changed to the number of the elevator going down.

In this case, when 45 degrees are turned to the right at a speed of 0.5 second, it may be set to change 10 numbers on the left in one-time spin angle. When 45 degrees are turned to the right at a speed of 1 second, it may be set to slowly increase a floor number on the left as much as a speed the user turns. For example, while “1” is indicated as the floor number on the left, in order to set “55th floor”, turn a dial 45 degrees 5 times at a speed of 0.5 second in each time, and turn it slowly at a speed of 1 second to set the 55th floor.

When a desired floor number is specified and the center is touched, the number of a floor is set and transmitted to the elevator, and a wavy ripple effect appears in the touched portion. Similarly, when the user wishes to move to a lower floor by turning to the left, a desired floor number is set via the spin speed and spin angle to be turned.

Although examples of the present disclosure have been described above with reference to the accompanying drawings, those having ordinary skill in the art to which the present disclosure pertains will understand that the present disclosure may be embodied in other specific forms without changing the technical spirit or essential features thereof. Therefore, it should be understood that the examples described above are illustrative in all aspects and not restrictive.

### INDUSTRIAL APPLICABILITY

It may be used in the field of controlling the operation of elevators.

What is claimed is:

1. An apparatus for controlling operations of a screenless elevator, comprising:
a display unit displaying a first image including a dial-shaped image;
a hologram projection unit displaying a second image in air, projecting the first image;
a motion recognition unit recognizing hand gesture of a user with respect to the second image by emitting light to the second image and receiving light reflected by the user's hand gesture from the second image; and
an operation control unit controlling an elevator to be operated by the hand gesture of the user.

2. The apparatus of claim 1,
wherein the display unit displays at least one of a floor number image displaying floor numbers of the elevator or an additional image displaying information relating to the elevator together with the dial-shaped image.

3. The apparatus of claim 1,
wherein the hologram projection unit projects the first image onto a first region predetermined based on three-dimensional coordinate system to display the second image. jq

4. The apparatus of claim 3,
wherein, when at least three fingers of the user touch and turn the dial-shaped image within a second region predetermined based on the three-dimensional coordinate system, the motion recognition unit detects a spin angle and a spin speed spun by at least three fingers of the user.

5. The apparatus of claim 4,
wherein the motion control unit controls the display unit such that the floor number image that displays floor number of the elevator is altered depending on the spin angle and the spin speed.

6. The apparatus of claim 1,
wherein the motion recognition unit detects, when five fingers of the user touch and spin the dial-shaped image, a spin angle and a spin speed spun by the five fingers of the user.

7. The apparatus of claim 6,
wherein the operation control unit controls the display unit, when the spin angle is greater than or equal to a reference angle and the spin speed is greater than or equal to a reference speed, such that the floor number image displaying floor number of the elevator changes in units of ten floors.

8. The apparatus of claim 6,
wherein the operation control unit controls the display unit, when the spin speed is less than a reference speed, such that the floor number image displaying floor number of elevator is altered in units of one floor.

9. The apparatus of claim 1,
wherein the motion recognition unit recognizes that finger of the user touches the center area of the dial-shaped image, when a first touch motion is made at a specific point within a center area of the dial-shaped image in a first direction where one finger of the user approaches the second image and a second touch motion is made at the specific point by moving one finger of the user in a second direction opposite to the first direction.

10. The apparatus of claim 9,
wherein the operation control unit, when the center area of the dial-shaped image is recognized as being touched, controls the display unit such that the center area of the dial-shaped image is displayed with emphasis.

11. The apparatus of claim 1,
wherein the motion recognition unit includes:
a light emitting module radiating an incident light to the second image;
a light receiving module receiving a reflected light reflected from the second image by a hand gesture of the user; and
an arithmetic module detecting the hand gesture of the user based on the incident light and the reflected light and calculating motion information by the hand gesture.

12. A method for controlling operations of a screenless elevator, comprising:
displaying a first image including a dial-shaped image;
displaying a second image projecting the first image onto a first region predetermined based on three-dimensional coordinate system;
recognizing hand gesture of the user regarding the second image within a second region predetermined based on the three-dimensional coordinate system; and
controlling operation such that an elevator operates in accordance with the hand gesture of the user.

13. The method of claim 12,
wherein the recognizing hand gesture includes detecting, when at least three fingers of the user touch and spin the dial-shaped image within the second region, a spin angle and a spin speed that three fingers of the user spin.

14. The method of claim 13, further comprising:
altering the first image such that a floor number image displaying floor number of the elevator is altered depending on the spin angle and spin speed.

15. The method of claim 12,
wherein the recognizing hand gesture includes:
detecting, when five fingers of the user touch and spin the dial-shaped image within the second region, a spin angle and spin speed spun by five fingers of the user.

16. The method of claim 15, further comprising:
altering, when the spin angle is greater than or equal to a reference angle and the spin speed is greater than or equal to a reference speed, the first image such that a floor number image displaying floor number of the elevator is altered in units of ten floors.

17. The method of claim 15, further comprising:
altering the first image, when the spin speed is less than reference speed, such that floor image displaying floor number of the elevator is altered in units of one floor.
